(19) United States
(12) Patent Application Publication
(10) Pub. No.: US 2025/0380667 A1
(43) Pub. Date: Dec. 18, 2025

(54) Gravity-secured attachment system with tool-free assembly for storage, display, or animal enrichment

(71) Applicant: Daniel Stephen Harrison, Rockingham, VA (US)

(72) Inventor: Daniel Stephen Harrison, Rockingham, VA (US)

(21) Appl. No.: 18/741,767

(22) Filed: Jun. 12, 2024

Related U.S. Application Data
(60) Provisional application No. 63/472,546, filed on Jun. 12, 2023.
(60) Provisional application No. 63/472,546, filed on Jun. 12, 2023.

(51) Int. Cl. A01K 15/02

(52) U.S. Cl. CPC A01K 15/024

(57) ABSTRACT

A furniture system that utilizes a gravity cleat assembly as the means of attaching a platform to a post without the use of tools, threaded tightening systems, or supplemental fasteners. The inventive gravity cleat assembly changes between a locked and unlocked state through variations in the relative angle of the platform that engage or disengage the assembly with the surface of the post. The posts can be connected to other posts and a base with the option of adding a top platform on any available connection point on the posts in the assembly. When assembled, the intermediary platforms can be disengaged and moved along the length of the assembled posts, and radially around the post to adjust placement without disassembling the system. The modularity and mobility without disassembly allows for users to easily and quickly change the embodiment of the invention to meet their changing needs.

### PRIORITY FILING

Priority Claims: The inventor claims priority on USPTO Application #63/472,546 Gravity-Secured Attachment System with Tool-Free Assembly for Animal Enrichment—Harrison, Daniel—Filed Jun. 12, 2023

Foreign: None

US: None

### CROSS-REFERENCE TO RELATED APPLICATIONS

Not Applicable

### STATEMENT REGARDING FEDERALLY SPONSORED RESEARCH OR DEVELOPMENT

Work for Hire: No

Work under US Government Contracts: No

Work under Foreign Government Contracts: No

Secret: No

### THE NAMES OF THE PARTIES TO A JOINT RESEARCH AGREEMENT

Not Applicable

### AN INCORPORATION BY REFERENCE STATEMENT

Not Applicable

### STATEMENT REGARDING PRIOR DISCLOSURES

Not Applicable

### BACKGROUND OF THE INVENTION

Home amenities have been a rapidly evolving realm of design—the conditions we provide for our home furnishings, our plants, our animals, and the role they play in the lives of people has been rapidly changing to accommodate the needs of an ever fluid and modular lifestyle. Many constructed home furnishings and animal environments and structures have prioritized cost and ease of manufacture at the expense of the well being and ease of use of animals and humans. Even today, many products intended for use in the home are made from fabrics that shed microplastics into the air in addition to using composite materials that can leach harmful chemicals. As consumers grow increasingly wary of the health impacts of commercial products, and as humanity's interest in the natural world and its growing love of—and resultant investment in—animal friends and family steadily increases, there is a need for a versatile product that addresses flexibility, modularity, cognitive enrichment requirements, is capable of being constructed using safe and environmentally conscious materials, and also facilitates cohabitation in human spaces and/or reliable use in outdoor and captive environments.

### FIELD OF THE INVENTION

The present invention relates to the design of home furniture, including stands, displays, and animal furniture, that is fully adjustable and modular without the use of hardware, tools, or proprietary widgets. This approach to modular design meets the basic functional requirements of the aforementioned products while offering a dynamic interaction with users with changing lifestyles and environments.

### DESCRIPTION OF RELATED ART

The field of readily adjustable, modular shelving and animal enrichment furniture has had a multitude of innovations that have come with various limitations to the adjustability. modularity, and overall utility of past inventions. With regards to shelving, adjustable furniture was achieved by U.S. Pat. No. 3,437,060A through the utilization of a wedge between horizontal and vertical members of the invention; U.S. Pat. No. 3,523,508A utilized four notched posts and frusto-conical sections to be mounted via an inwardly extending rib to said posts and the shelf member lowered on top of these attachments, with US20080185357A1 utilizing the same invention within the novel context of a singular pole; and U.S. Pat. No. 11,896,122B1 also exploring adjustable attachment on a single post with novel in-situ adjustment utilizing a plug-in assembly to connect and disconnect storage without tools. With regard to animal enrichment furniture, vertical structures with flat shelves for cats, in particular, were achieved by U.S. Pat. No. 3,479,991A with a central column requiring installation to the floor and ceiling using a threaded plug and adhesive on a load-bearing surface with the platforms being securely held between two vertical parts, and U.S. Pat. No. 3,479,990A has a similar form-factor but is secured to the floor and ceiling via compression and platforms mounted to the central pole with L-brackets; more recent innovations in the modularity of enrichment furniture have facilitated the custom assembly, disassembly, and reattachment of various parts using reversible attachment methods such as interlocking dovetail joints by U.S. Pat. No. 5,465,682A and a releasable threaded connector assembly by U.S. Pat. No. 5,577,466A. There are two instances of prior art that directly relate to the novel mechanism of this invention, XL Industries sells a metal vertical shelf for prefabricated stands that allows for the attachment and removal of platforms horizontally for ease of rearrangement while assembled, and US20020092705A1 is a tool for climbing utility poles that attaches horizontally and utilizes a similar mechanical force as the present invention.

### BRIEF SUMMARY OF THE INVENTION

A new type of furniture is invented that utilizes a novel static assemblage for freely adjustable shelving or platforms without the use of hardware, tools, custom fittings, or built-in release systems such as knobs, spring-releases, or similar. The application of this novel technology achieves a new degree of dynamic furniture that caters to a wide range of users. The present invention can accommodate a wide variety of applications including but not limited to: storing or displaying items such as books, potted plants, decorations, and facilitating animal enrichment for a wide variety of species and environmental conditions due to its diverse range of methods of assembly while maintaining the core mechanism of the present invention. The new type of invented furniture additionally provides an aesthetically pleasing structure for the human users, who also benefit from its low-weight form-factor, maximized ease of construction due to its tool-free assembly, and the ability to arrange platforms in a variety of ways to serve various functions.

### BRIEF DESCRIPTION OF THE SEVERAL VIEWS OF THE DRAWING

FIG. 1 is a perspective view of the gravity-secured attachment system assembled with multiple intermediary platforms.

FIG. 2 is a cross-sectional front view of FIG. 1 demonstrating an embodiment of the central column and stand that supports the gravity-secured attachments.

FIG. 3 is an exploded front view of FIG. 2 to clarify the types of material and hardware being used in this embodiment of the invention.

FIG. 4 is a bottom view of the gravity-secured attachment in the form of a tear-shaped flat platform.

FIG. 5a is a side view of the gravity-secured attachment platform of FIG. 4 in its unlocked orientation.

FIG. 5b is a side view of the gravity-secured attachment platform of FIG. 4 in its locked orientation.

The described drawings illustrate one possible assembly of the modular invention within all of the potential embodiments of the present invention, but are not, however, intended to limit this disclosure to the modes of assembly shown in said drawings.

### DETAILED DESCRIPTION OF THE INVENTION

The invention consists of the following components—

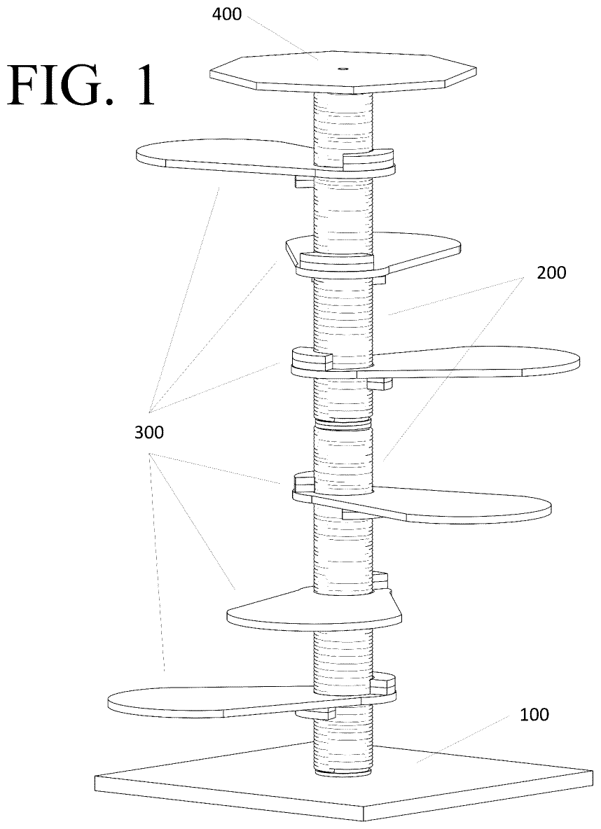

As shown in FIG. 1—The invention contains a base 100, at least one post 200, at least one intermediary platform with gravity cleat assembly 300, and a top platform 400.

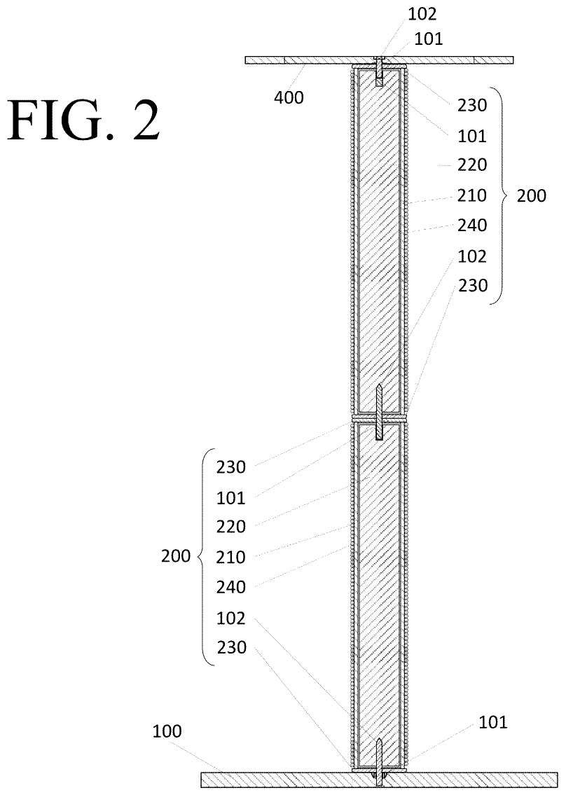

A base plate 100 made of wood, or plastic, or similar material; as shown in FIG. 2 containing a nut-style fastener 101, such as T-nuts, or insert nuts, or similar, centered on the base 100 or in multiple equidistant locations around the base 100, and an optional cover designed to be temporary or permanently affixed.

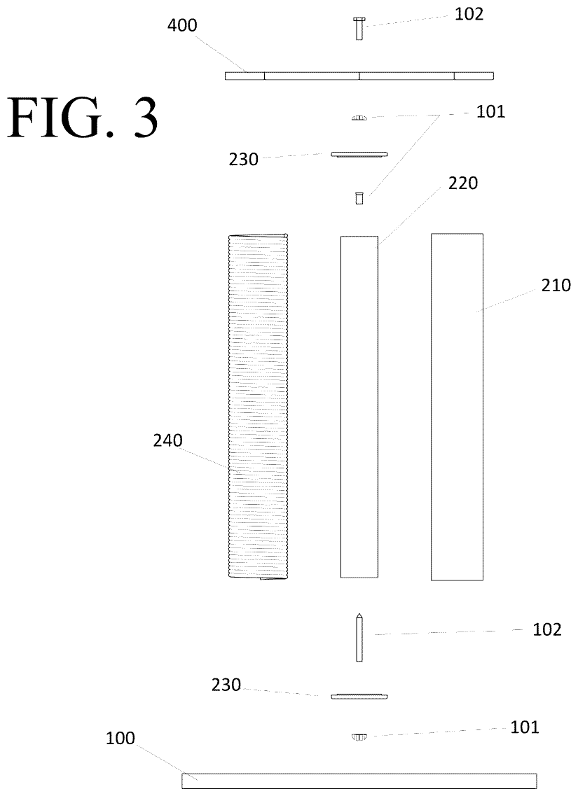

Multiple posts 200 as shown in FIG. 2, can connect to form a post assembly. A post 200 as shown in FIG. 3, is made with a cylinder 210 made of plastic, wood, cardboard, or similar materials, with an outer and inner diameter being determined by the strength requirements of the given use case of the invention. The cylinder 210 can have a core 220 made of wood, metal, plastic, or similar materials that runs the full length; or have two small pieces fastened within either end of the cylinder; or be omitted entirely, depending on the use case and material used. The post 200 may have caps 230 that set into the ends of the cylinder 210 and can extend beyond its lip. The post can be wrapped with a textile 240, such as sisal, hemp, cotton, or other material of rope or fabric, that can be secured to or through the cylinder 210 to the core 220 and/or caps 230. The post 200 has a bolt-style fastener 102, such as a hanger bolt or similar, centered in one end for attachment to the base 100, and a nut-style fastener 101, at the other end for attaching other posts 200 or a top platform 400.

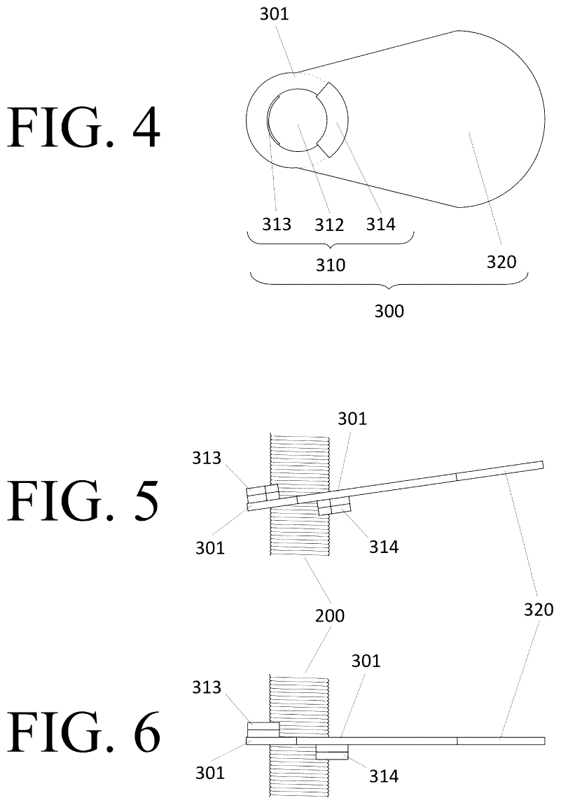

One or more intermediary platforms 300 as shown in FIG. 4, consisting of a plate 301 made of wood, plastic, or similar material, delineated into two sections: the gravity cleat assembly 310 and the functional surface 320. The gravity cleat assembly 310 is located at the far end of the plate 301 with a through-hole 312 that is slightly larger than the outer diameter of the post 200 (accounting for the wrapped textile 240, if applicable); affixed to either face of the plate 301 and either side of the through-hole 312 are two curved blocks whose inner curvatures match, and are concentric to the through-hole 312: one block, the heel 313, is affixed to the top outer side of the plate 301 (furthest from the functional surface 320), and the other block, the toe 314, is affixed to the bottom inner side of the plate 301—the heel 313 and toe 314 are both, at least twice the thickness of the plate 301. The heel 313 and toe 314 are inset towards the center of the through-hole 312 to match, or slightly undercut, the outer diameter of the post 200, as previously described. The functional surface 320 acts as a counterweight, enabling the functionality of the gravity cleat assembly 310. The intermediary platform 300 is held in place by the gravity cleat assembly 310 which also allows for ease of repositioning and reconfiguring the assembly by the user, as shown in FIG. 5a—the intermediary platform 300 is unlocked and able to move along the height of the post 200, and FIG. 5b—the intermediary platform 300 is locked and held securely to the post 200 with the weight provided by the wide surface area of the functional surface 320.
The inner faces of the heel 313 and toe 314 of the gravity cleat assembly 310, nearest to the central through-hole 312, may be constructed/augmented in a variety of ways (depending on the materiality of the post 200 and intended use case), including but not limited to:
   with smooth surfaces
   adding friction tape
   adding rubberized tape
   inserting metal studs
   cutting teeth into the solid/laminated/composite material
      any of these methods may be permanently affixed or attached by means of staples, screws, or insert nuts with screws/bolts to afford adjustable tension to the gravity cleat assembly 310
The functional surface 320 can take a variety of forms, all of which can be bare or upholstered, including but not limited to:
   flat or vertical surface
   tear drop, round, square, rectangular, ovular, or irregularly shaped surface
   internal or under-hanging basket surface
   surface with central or multiple hole(s)
   surfaces joined together horizontally to form a ramp
   surfaces joined together vertically to form an enclosure
   uneven or intentionally “loose” surface
   (Any upholstery related to the aforementioned functional surface 320 forms may be permanently affixed or take the form of a temporary, easily replaceable cover.)

Top platform 400 as shown in FIG. 2, made of wood, plastic, or similar material, containing nut-style fasteners 101, centered on, or in multiple equidistance locations around the top platform 400, a bolt-style fastener 102 with each nut-style fastener 101 to affix the top platform 400 to the top of a post 200, and it can also have a cover that has been designed to be temporarily or permanently affixed.

### Embodiments

The present invention has the capacity to achieve a wide variety of embodiments based on its intended use case—considering both the user and the environment—and therefore, the best mode for carrying out the invention is highly dependent on the specific use case. However, the inventor has contemplated the best mode for carrying out the invention for a mid-sized domesticated mammal (2-20 kg) in the home, which consists of:
One square, plywood, base upholstered with a removable natural-fiber burlap fabric underlaid with a natural fiber batting, four “slider” feet affixed to the bottom, and 9 t-nuts installed at center and equidistant around the base.
One post, composed of a plastic or wood cylinder with two semi-circular cutouts at the lip of either end, and may contain a rectangular pine wood core which is rounded to fit to the inner diameter of the cylinder and is shorter than said cylinder by approximately 2 cm on either end. The wood core is centered in the cylinder and is secured using 8 screws: two sets of two screws are inserted through the cylinder and wood core across from one another on each end of the pipe (4 screws total) and a set of 2 screws are inserted through the cylinder and wood core at one third of its length, and again at two-thirds of its length (4 screws total). A hanger bolt or similar fastener is installed at the bottom of the post assembly in the center of the wood core, and an insert nut or similar fastener is installed at the top of the post assembly in the center of the wood core. The cylinder is then tightly wrapped (ideally using a motorized mechanism) with a natural fiber rope, approximately one-quarter-inch in diameter and long enough to cover the entire outer surface of the cylinder with enough spare length to feed through the semi-circular cutouts at either end of the cylinder and secure said rope-ends to each end of the wood core using 2 staples for each end. The post assembly is finished with two hardwood caps with an inset lip that extends slightly beyond the lip of the cylinder that are attached to the wood core by 2 screws on either side of the hardware affixed at either end of the post assembly.
Three or more intermediary platforms, each consisting primarily of a plate that has a wide section away from the post, the functional surface, and a narrow section at the attachment end. The plate is made of plywood with the functional surface of the platform upholstered with a removable cover, and the smaller end composing the gravity cleat assembly: having a central through-hole that is slightly larger than the final diameter of the post assembly (with at least one inch of external material) and two curved blocks—each made of two layers of hardwood with eighth-inch pyramidal or “teeth” shapes positively cut into the face of the inner-curved portion of each block—both affixed using staples with the first block attached to the top back of the attachment section serving as the heel and the second block attached to the bottom across from the previously attached block serving as the toe of the gravity cleat assembly. Both blocks' inner curves sit concentrically to the through-hole, and are inset to a slightly smaller diameter than the final diameter of the post assembly. The removable cover for the platform section of the intermediary platforms is made of the same materials as the base, and is sewn using traditional methods so it can be attached and removed easily by the user.
One plywood, top platform is smaller than the base (in its longest dimension) by at least four inches with a T-nut installed in the center bottom and a bolt that is inset flush to the platform and inserted through the top of the platform through the T-nut until snug. The top platform is upholstered with the same materials as the base and intermediary platforms.
The post assembly is attached to the base by screwing the bolt-style fastener located at the base of the post assembly into the fastener installed in the center of the base. The intermediary platforms are then installed by sliding the through-hole over the top of the post assembly at a slight upward angle—with the functional surface higher than the gravity cleat assembly—until the intended height/position is reached, then the platform is tilted level, which causes the teeth along the inner curvature of the curved blocks to bite into the rope wrappings to provide additional friction and holding power to the gravity-activated cantilever compression grip. Finally, the top platform is attached to the top of the post assembly by screwing the bolt located at the center bottom of the top platform into the fastener installed in the top of the wood core in the post assembly until the top platform is secure without overtightening.

This conceptualized “best mode” is the result of multiple rounds of physical prototyping, testing, and feedback. This process is ongoing and, consequently, the “best mode” of implementation, as identified by the inventor, is continually evolving. It can be asserted, confidently and in good faith, that the presently described “best mode” will at minimum remain a more-than-acceptable mode for carrying out the present invention when it is used for mid-sized domesticated animals in indoor environments (eg. the home), will adequately store or display items such as books, accessories, potted plants, or decorations, and it may very well prove itself to be the long-term best mode if omitting aesthetic form variations and patently obvious material alternatives.

1. A gravity-secured attachment system consisting of:
a base, the base contains at least one centered internal attachment;
at least one post, each post has a top end containing an internal attachment and a bottom end containing an external attachment;
at least one intermediary platform, each intermediary platform is an assembly of a single plate and two curved blocks and has a front edge, a back edge, a top face, and a bottom face with a single line of symmetry from the front edge to the back edge; and
at least one top platform, each top platform has an external attachment affixed to the bottom center.

2. The gravity secured attachment system of claim 1, wherein the base, post, intermediary platform, and top platform may be upholstered using a variety of permanently or temporarily affixed textiles.

3. The system of claim 1, wherein the base must have dimensions configured to support static and dynamic loads.

4. The system of claim 1, wherein the intermediary platform must be constructed of materials that will bear static and dynamic loads.

5. (canceled)

6. The system of claim 1, wherein the installation, arrangement, or adjustment of any intermediary platform must not use power tools, hand tools, screws, internal wedges, snaps, or other supplemental locking systems that must be engaged or inserted to secure said platform in place.

7. The system of claim 1, wherein the plate of the intermediary platform has a through-cut hole, of an internal diameter that is larger than the outer diameter of the post, that is centered along the line of symmetry and positioned near the back edge without removing material that will threaten the structural integrity of the plate.

8. The system of claim 1, wherein the inner circumferential face of the curved blocks is smooth, cut with ridges or pyramidal teeth, or has an additive medium.

9. The system of claim 1, wherein the curved blocks of the intermediary platform each have an inner arch that is concentric with the through-hole, and of a total length less than one third of the circumference of said hole, and are affixed to the plate with the inner curve offsetting the hole without reducing the overall internal diameter to less than the diameter of the post, with one block positioned near the back edge on the top face and the other block positioned closer to the front edge on the bottom face.

10. The system of claim 1, wherein the method by which the platform attaches to the post is by inserting the post into the through-hole in the platform while the platform is angled with the front edge higher than the back edge and then lowering the front edge of the platform to be parallel with the back edge, utilizing friction and gravity by means of a cantilever action to secure the platform to the post.
